(19) United States
(12) Patent Application Publication
(10) Pub. No.: US 2012/0199517 A1
(43) Pub. Date: Aug. 9, 2012

(54) PROCESS FOR THE RECOVERY OF OILS FROM A SOLID MATRIX

(75) Inventors: Lucilla Del Gaudio, San Donato Milanese (MI) (IT); Paola Albonico, Milano (IT); Alessandra Belloni, Cerro al Lambro (MI) (IT); Paola Favaro, Milano (IT)

(73) Assignee: ENI S.p.A., Rome (IT)

(21) Appl. No.: 13/496,751

(22) PCT Filed: Sep. 8, 2010
(86) PCT No.: PCT/IB2010/002257

§ 371 Date: Apr. 24, 2012

(30) Foreign Application Priority Data
Sep. 18, 2009 (IT) MI2009A 001598

(51) Int. Cl. C10G 1/04; B82Y 30/00

(52) U.S. Cl. 208/391; 208/390; 977/902

(57) ABSTRACT

Process for the recovery of oils from a solid matrix comprising: subjecting said solid matrix to extraction by mixing with an oil-in-water nanoemulsion, obtaining a solid- liquid mixture; subjecting said solid- liquid mixture to separation, obtaining a liquid phase comprising said oils and a solid phase comprising said solid matrix; recovering said oils from said liquid phase. Said process is particularly advantageous for the recovery of oils from water wet oil sands (or water wet tar sands), oil wet sands (or oil wet tar sands), oil rocks, oil shales, more specifically from oil wet sands (or oil wet tar sands).

The present invention relates to a process for the recovery of oils from a solid matrix.

More specifically, the present invention relates to a process for the recovery of oils from a solid matrix by means of extraction with an oil-in-water nanoemulsion.

Said solid matrix is preferably selected from water wet oil sands (or water wet tar sands), oil wet sands (or oil wet tar sands), oil rocks, oil shales. Said solid matrix is even more preferably selected from oil wet sands (or oil wet tar sands).

It is known that many hydrocarbon reserves currently available are represented by water wet oil sands (or water wet tar sands), oil wet sands (or oil wet tar sands), oil rocks, oil shales, containing the so-called non-conventional oils, i.e. extra heavy oils or tars. Said non-conventional oils have an extremely high density, generally lower than 15° API, and also a very high kinematic viscosity, generally higher than 10000 cps, said kinematic viscosity being measured at the original reservoir temperature, at atmospheric pressure, in the absence of gas: consequently, said non-conventional oils do not flow spontaneously under the reservoir conditions.

Oil sands (or tar sands) are generally characterized both by their mineralogy and by the liquid medium which is in contact with the mineral particles of said oil sands (or tar sands). Water wet oil sands (or water wet tar sands), for example, comprise mineral particles surrounded by a water casing, normally known as connate water. The oils contained in said water wet tar sands are generally not in direct contact with the mineral particles, but rather form a relatively fine film which surrounds the water enclosing said mineral particles.

Oil wet sands (or oil wet tar sands), on the other hand, can include small quantities of water, but the mineral particles are not generally surrounded by said water and the oils contained therein are in direct contact with said mineral particles. Consequently, in the case of said oil wet sands (or oil wet tar sands) the extraction of the oils is more difficult with respect to the extraction of the same from said water wet oil sands (or water wet tar sands). Both water wet oil sands and oil wet sands generally contain a high percentage, about 90%, of mineral particles having an average dimension ranging from 0.1 mm to 6 mm and can also be extremely acid (e.g., with a pH lower than 4) depending on the mineralogy of these oil sands.

Technologies for exploiting these oil sands and for the extraction of said non-conventional oils are known in the art.

The exploiting of these oil sands can be carried out by applying various mining processes which are generally divided into two categories:
strip mining which is normally applied when the oil sands are localized up to maximum depths of about 90 m-100 m;
“in-situ” mining which is generally applied when the oil sands are localized at depths higher than 200 m.

The costs associated with the exploiting of the above oil sands through the above mining processes, however, are generally high due to the high energy consumptions (particularly in the case of strip mining) and also as a result of the necessity of using costly technologies (particularly in the case of “in-situ” mining).

Strip mining is a process which requires the use of excavation and transport machinery which allow mining on different quarry faces. In this case, the mining is carried out by the recession of a single terrace (or quarry face), or by the excavation of descending horizontal sections. As indicated above, strip mining is generally used in the case of reservoirs situated at a few tens of metres of depth (to a maximum of 90 m-100 m).

The material obtained by strip mining is normally subjected to grinding to reduce the dimension of the agglomerates, to limit the cohesion between the same and, at the same time, to increase the overall effective surface, in the sense of the surface of said material which will be subsequently exposed to the action of the extraction solvent. In this way, the stony rock (e.g., quartz sandstone with slightly cemented bitumen) becomes loose rock, or “earth”. This grinding is normally carried out at a temperature which does not cause aggregation phenomena of the bituminous substance contained in said material, and allows particles (i.e. tailings) to be obtained, having the particle size of sand (<2 mm).

Hot water is normally added to the particles thus obtained, together with possible chemical additives, to form a “slurry”, which is subsequently fed to an oil extraction plant, where it is subjected to shaking. The combined action of hot water and shaking, causes the adhesion of small air bubbles to the oils, forming a bitumen froth which rises to the surface and can be recovered. The remaining part can be further treated to remove the residual water and the oil sand.

The oils thus extracted, which are heavier than the conventional oils, can be subsequently mixed with light oil (liquid or gas), or they can be chemically separated and subsequently upgraded for producing synthetic crude oil.

The above process is extremely widespread and diversified and is normally applied to the oil sands of Western Canada, which can normally be found at a few tens of metres of depth.

In this context, the production of a barrel of oil requires the treatment of about two tons of oil sand, with a recovery yield of the oils from the formation equal to about 70%, said yield being calculated with respect to the total quantity of the oils present in said formation. The tailings, namely the particles already treated, which contain a hydrocarbon fraction which has not been removed, can be further treated until a recovery yield of said oils equal to about 90% has been reached.

The above process, however, cannot be used in the case of reservoirs situated at higher depths. In this case, “in situ” mining processes are generally applied, which are mainly aimed at reducing the oil viscosity in the reservoir, situated at a depth of a few hundreds to thousands of metres, by the introduction of vapour, solvents and/or hot air into the reservoir.

“In situ” mining processes can be divided into three categories:
cold “in situ” mining processes
hot “in situ” mining processes
chemical “in situ” mining processes

Among the cold “in situ” mining processes, the underground excavation (“Oil Sand Underground Mining”—(OSUM) is known. Said process is generally applied to the oil sand reservoirs of Western Canada and to almost all of those in Venezuela, which are in fact situated at depths which make the strip mining process described above, uneconomical. Said process, however, can at times also be advantageously applied to reservoirs situated at depths lower than 50 m.

Another known cold “in situ” mining process is the cold flow process (“Cold Heavy Oil Production with Sand”—CHOPS) which allows the recovery of oils directly from the sand reservoir, operating at high pressure difference values (ΔP). The oils are generally pumped to the surface using progressive cavity pumps to obtain an increase in the production. The oils which reach the surface are subsequently separated from the sand. Said process is commonly used in the reservoirs of Venezuela and Western Canada. Said process has the advantage of being economical but the disadvantage of allowing a low recovery yield of the oils, said yield being equal to 5% -6% with respect to the total quantity of the oils present in the reservoir. By removing the filters which prevent the fine particles from flowing from the reservoir towards the surface, the production of sand associated with oils increases considerably causing the formation of winding ducts in the subsoil and allowing an increase in the oil recovery factor (recovery yield equal to about 10% with respect to the total quantity of the oils present in the reservoir).

Among hot “in situ” mining processes, cyclic steam stimulation (“Cyclic Steam Stimulation”—CSS) is known. Said process, also known as “huff-and-puff”, is based on the cyclic introduction of high-temperature (300° C.-400° C.) steam into the reservoir, through a horizontal well, for prolonged periods (weeks to months), to allow the steam to heat the mineralized formation and to fluidify the oils which can thus be recovered at the surface. The production, and therefore, the recovery of the oils, takes place through another horizontal, well situated at a higher depth. Said process, widely used in Canada, can be repeated several times on the basis of technical and economic verifications. Although it allows a good recovery of the oils, with a recovery yield equal to about 200 -25% with respect to the total quantity of the oils present in the reservoir, said process is disadvantageous from an economical point of view as it has high running costs.

Another hot “in situ” mining process is the steam aasisted gravity drainage (“Steam Assisted Gravity Drainage”—SAGD). The development of directed drilling techniques has allowed this process to be developed, which is based on the drilling of two or more horizontal wells at a few metres of distance in vertical with respect to each other and with an extension of kilometres with different azimuths. The steam is introduced into the upper well, the heat fluidifies the oil which accumulates by gravity in the lower well from which it is collected and pumped to the surface.

Said process, which can also be applied to the mineral mining of shallow reservoirs, provided they have a higher thermal coverage, is more economical with respect to the cyclic steam stimulation (CSS) process and leads to a good oil recovery yield, said yield being equal to about 60% with respect to the total quantity of the oils present in the reservoir.

Among chemical “in situ” mining processes, the vapour extraction (“Vapour Extraction Process”—VAPEX) is known. Said process is similar to the steam assisted gravity drainage (SAGD) process, but hydrocarbon solvents are introduced into the reservoirs instead of steam, obtaining a better extraction efficiency and favouring a partial upgrading of the oils already inside the reservoir. The solvents are costly, however, and have a considerable impact on both the environment and safety of the work site (e.g., risks of fires and/or explosions).

The above processes, however, can have various drawbacks. These processes, for example, require the use of high quantities of water which is only partly recycled and must therefore be subjected to further treatments before being disposed of. In the case of Western Canada, for example, the volume of water necessary for producing a single barrel of synthetic crude oil (SCO), is equal to 2 -4.5 times the volume of oil produced. Furthermore, these processes are generally characterized by a low extraction yield.

Attempts have been made in the art to overcome the above drawbacks.

American patent U.S. Pat. No. 4,424,112, for example, describes a process and apparatus for the extraction with solvent of tar oils from oil sands and their separation into synthetic crude oil and synthetic fuel oil which comprises mixing the oil sands with hot water so as to form a slurry together with the solvent (e.g., toluene), subjecting said slurry to separation so as to obtain a phase comprising solvent and dissolved tar oils and a phase comprising solid material deriving from said oil sands, separating the tar oils from the solvent, putting the tar oils thus obtained in contact with an extraction agent (e.g., methyl butyl ketone) in order to separate the tar oils into synthetic crude oil and synthetic fuel oil, recovering and re-using the solvent, water and extraction agent in the process.

American patent U.S. Pat. No. 4,498,971 describes a process for the separate recovery of oils on the one hand and of asphaltenes and of polar compounds on the other, from oil sands. This process comprises: cooling the oil sands to a temperature ranging from −10° C. to −180° C. at which said sands behave like a solid material, grinding said solid material at said temperature to obtain relatively coarse particles containing most of the sand and oil and relatively fine particles containing most of the asphaltenes and of the polar compounds, and mechanically separating the relatively coarse particles from the relatively fine particles at said temperatures. Said relatively coarse particles are subjected to extraction with solvent (e.g., pentane, hexane, butane, propane) at a temperature ranging from about −30° C. to about −70° C., in order to recover the oil. Said relatively fine particles are subjected to extraction with solvent (e.g., pentane, hexane, butane, propane) at a temperature ranging from about −30° C. to about −70° C., in order to recover the asphaltenes and the polar compounds.

European patent application EP 261,794 describes a process for the recovery of heavy crude oil from tar sand which comprises treating said tar sand with an emulsion of a solvent in water characterized in that the emulsion contains from 0.5% by volume to 15% by volume of solvent. Solvents which are useful for the purpose include hydrocarbons such as, for example, hexane, heptane, decane, dodecane, cyclohexane, toluene, and halogenated hydrocarbons such as, for example, carbon tetrachloride, dichloromethane.

Not even are the above processes, however, capable of providing the required performances. It is not always possible, for example, to obtain a good recovery of said oils, particularly in the case of oil wet sands (or oil wet tar sands).

The Applicant has therefore faced the problem of finding a process which allows an improved recovery of oils from a solid matrix, in particular from tar sands, more in particular from oil wet sands (or oil wet tar sands).

The Applicant has now found that the recovery of oils from a solid matrix can be advantageously carried out by means of a process which comprises subjecting said solid matrix to extraction in the presence of an oil-in-water nanoemulsion.

Said process allows a good recovery yield of the oils to be obtained, i.e. an oil recovery yield higher than or equal to 60%, said yield being calculated with respect to the total quantity of the oils present in the solid matrix. Furthermore, said process allows a final solid residue to be obtained, i.e. deoiled solid matrix, with characteristics which allow it to be replaced “in situ” without the necessity for further treatments.

An object of the present invention therefore relates to a process for the recovery of oils from a solid matrix comprising:
subjecting said solid matrix to extraction by mixing with an oil-in-water nanoemulsion, obtaining a solid-liquid mixture;
subjecting said solid-liquid mixture to separation, obtaining a liquid phase comprising said oils and a solid phase comprising said solid matrix;
recovering said oils from said liquid phase.

Before being subjected to extraction, said solid matrix can generally be subjected to grinding in order to obtain particles with reduced dimensions and which can therefore be easily treated in the above process.

Said grinding can be carried out using equipment known in the art such as, for example, hammer mills, knife mills, or the like. Said grinding is preferably carried out at a temperature which does not cause the softening of the solid matrix.

Before being subjected to grinding, said solid matrix can be optionally cooled to below the glass transition temperature of the oils present in said solid matrix.

According to a preferred embodiment of the present invention, said oil-in-water nanoemulsion can comprise a dispersed phase (i.e. oil) and a dispersing phase (i.e. water and surfactants).

According to a preferred embodiment of the present invention, said liquid phase can also comprise water and surfactants deriving from said oil-in-water nanoemulsion.

Said liquid, phase can optionally comprise a residual quantity of said solid matrix (in particular, fine particles of said solid matrix).

Said solid phase can optionally comprise a residual quantity of water and surfactants deriving from said nanoemulsion.

It should be noted that the quantity of oil contained in said nanoemulsion remains almost completely in the oils recovered from said solid matrix. Traces of said oil, however, can be optionally present in said liquid phase and/or in said solid phase.

It should also be noted that the quantity of oil of the nanoemulsion which remains in the oils recovered is in any case minimum and does not negatively influence either the subsequent treatments to which said oils are subjected, or their subsequent use. It should also be noted that said minimum quantity of oil of the nanoemulsion in the oils recovered can advantageously reduce the viscosity and density of the same.

For the purposes of the present description and of the following claims, the term “oils” indicates both extra heavy oils, and tars, present in said solid matrix (i.e. so-called non-conventional oils).

For the purposes of the present description and of the following claims, the definitions of the numerical ranges always comprise the extremes unless otherwise specified.

According to a preferred embodiment of the present invention, said solid matrix can be selected from water wet oil sands (or water wet tar sands), oil wet sands (or oil wet tar sands), oil rocks, oil shales. Said solid matrix is preferably selected from oil wet sands (or oil wet tar sands).

According to a preferred embodiment of the present invention, in said oil-in-water nanoemulsion, the dispersed phase (i.e. oil) can be distributed in the dispersing phase (i.e. water and surfactants) in the form of droplets having a diameter ranging from 10 nm to 500 nm, preferably from 15 nm to 200 nm.

Oil-in-water nanoemulsions particularly suitable for the purposes of the above process can be prepared according to what is described in international patent application WO 2007/112967 whose content is incorporated herein as reference. Said process allows monodispersed oil-in-water nanoemulsions to be obtained, having a high stability and having the dispersed phase (i.e. oil) distributed in the dispersing phase (i.e. water and surfactants) in the form of droplets having a high specific area (area/volume) (i.e. a specific area higher than or equal to 6,000 m²/l).

According to a preferred embodiment of the present invention, said oil-in-water nanoemulsion can be prepared according to a process comprising:
the preparation of a homogeneous water/oil mixture (1) characterized by an interface tension lower than or equal to 1 mN/m, preferably ranging from 10⁻² mN/m to 10⁻⁴ mN/m, comprising water in a quantity ranging from 65% by weight to 99.9% by weight, preferably ranging from 70% by weight to 99% by weight, with respect to the total weight of said mixture (1), at least two surfactants having a different HLB, selected from non-ionic, anionic, polymeric surfactants, preferably non-ionic surfactants, said surfactants being present in such a quantity so as to make said mixture (1) homogeneous;
the dilution of said mixture (1) in a dispersing phase consisting of water with the addition of at least one surfactant selected from non-ionic, anionic, polymeric surfactant, preferably non-ionic surfactants, the quantity of said dispersing phase and of said surfactant being such as to obtain an oil-in-water nanoemulsion having a HLB higher than that of said mixture (1).

According to a preferred embodiment of the present invention, said oil-in-water nanoemulsion can have a HLB value higher than or equal to 9, preferably ranging from 10 to 16.

According to a preferred embodiment of the present invention, in said oil-in-water nanoemulsion, the dispersed phase (i.e. oil) can be distributed in the dispersing phase (i.e. water) in the form of droplets having a specific area (area/volume) ranging from 6,000 m²/l to 300,000 m²/l, preferably ranging from 15,000 m²/l to 200,000 m²/l.

According to a preferred embodiment of the present invention, said oil-in-water nanoemulsion can comprise a quantity of surfactants ranging from 0.1% by weight to 20% by weight, preferably from 0.25% by weight to 12% by weight, and a quantity of oil ranging from 0.5% by weight to 10% by weight, preferably from 1% by weight to 8% by weight, with respect to the total weight of said oil-in-water nanoemulsion.

According to a preferred embodiment of the present invention, said surfactants can be selected from non-ionic surfactants, such as, for example, alkyl polyglucosides; esters of fatty acids of sorbitan; polymeric surfactants such as, for example, grafted acrylic copolymers having a backbone of polymethyl methacrylate—methacrylic acid and side-chains of polyethylene glycol; or mixtures thereof.

According to a preferred embodiment of the present invention, said oil can be selected from aromatic hydrocarbons such as, for example, xylene, mixtures of xylene isomers, toluene, benzene, or mixtures thereof; linear, branched or cyclic hydrocarbons such as, for example, hexane, heptane, decane, dodecane, cyclohexane, or mixtures thereof; complex mixtures of hydrocarbons such as, for example, diesel fuel, kerosene, soltrol, mineral spirit, or mixtures thereof; or mixtures thereof.

With respect to the water which can be used for the preparation of the above nanoemulsions, this can be of any origin. For economic reasons, it is preferable for said water to be available close to the preparation site of said oil-in-water nanoemulsion.

According to a preferred embodiment of the present invention, demineralized ,water, saline water, added water, or mixtures thereof, can be used.

According to a preferred embodiment of the present invention, in said solid/liquid mixture, the weight ratio between said solid matrix and said oil-in-water nanoemulsion can range from 1:0.1 to 1:2, preferably from 1:0.5 to 1:1.

According to a preferred embodiment of the present invention, in said solid/liquid mixture, the oil contained in said oil-in-water nanoemulsion can be present in a quantity ranging from 0.1% by weight to 30% by weight, preferably from 1% by weight to 25% by weight, with respect to the total weight of the oils present in said solid matrix.

In order to saponify the naphthene acids generally present in said solid matrix, at least one base can be added to said oil-in-water nanoemulsion.

According to a further embodiment of the present invention, at least one base can be added to said oil-in-water nanoemulsion in a quantity ranging from 0.1% by weight to 10% by weight, preferably from 0.2% by weight to 5% by weight, with respect to the total weight of said oil-in-water nanoemulsion. Said base is preferably selected from sodium hydroxide, potassium hydroxide, sodium carbonate, potassium carbonate, sodium metaborate, or mixtures thereof.

Said mixing, (i.e. the mixing of said solid matrix with said oil-in-water nanoemulsion), can be carried out in mixers known in the art such as, for example, vortex-mixers, magnetic mixers, or the like.

According to a preferred embodiment of the present invention, the mixing of said solid matrix with said oil-in-water nanoemulsion, can be carried out for a time ranging from 5 minutes to 5 hours, preferably from 6 minutes to 2 hours.

According to a preferred embodiment of the present invention, the mixing of said solid matrix with said oil-in-water nanoemulsion, can be carried out at a temperature ranging from 5° C. to 90° C., preferably from 20° C. to 80° C.

According to a preferred embodiment of the present invention, the mixing of said solid matrix with said oil-in-water nanoemulsion, can be carried out at a pH ranging from 7 to 13, preferably from 8 to 12.

Said solid matrix can be subjected to extraction once or more times. Said solid matrix is preferably subjected to extraction from 1 to 10 times, more preferably from 1 to 3 times.

According to a preferred embodiment of the present invention, the separation of said solid-liquid mixture can be carried out by sedimentation, centrifugation, preferably sedimentation.

As already specified, said liquid phase can also comprise water and surfactants deriving from said nanoemulsion.

According to a preferred embodiment of the present invention, said liquid phase can comprise a quantity of oils higher than or equal to 60% by weight, preferably ranging from 70% by weight to 99.9% by weight, with respect to the total quantity of the oils present in said solid matrix.

According to a preferred embodiment of the present invention, said solid phase can comprise a quantity of oils lower than or equal to 40% by weight, preferably ranging from 0.1% by weight to 30% by weight, with respect to the total quantity of the oils present in said solid matrix.

According to a preferred embodiment of the present invention, the recovery of said oils from said liquid phase can be carried out by means of centrifugation, cycloning, filtration, flotation, preferably flotation, obtaining oils and water substantially free of said oils. Said water can optionally comprise surfactants deriving from said oil-in-water nanoemulsion.

In order to facilitate the recovery of the oils contained in said liquid phase, an oil-absorbing polymer can be used. At least one oil-absorbing polymer can therefore be optionally added to said liquid phase, obtaining substantially oil-free water and said at least one oil-absorbing polymer comprising said oils. Said oil-absorbing polymer comprising said oils can be separated from the water by cycloning, filtration, flotation, preferably filtration. Said oil-absorbing polymer can be subsequently subjected to pressing or centrifugation in order to recover said oils. Said water can optionally comprise surfactants deriving from said oil-in-water nanoemulsion.

The recovered oils can be sent to subsequent treatments such as, for example, upgrading treatments via hydrogenation or hydrocracking, in order to obtain hydrocarbon fractions having a higher commercial value.

Said water, optionally comprising surfactants deriving from said oil-in-water nanoemulsion can be recycled and re-used for the preparation of said oil-in-water nanoemulsion.

In order to recover the residual quantity of solid matrix optionally present in said liquid phase, said liquid phase can be optionally subjected to filtration before being sent for the recovery of said oils.

In order to recover the residual quantity of water and surfactants optionally present in said solid phase, said solid phase can be subjected to high-temperature thermal desorption.

According to a preferred embodiment of the present invention, said solid phase can be subjected to thermal desorption, at a temperature ranging from 50° C. to 150° C., preferably ranging from 60° C. to 90° C. Said water and surfactants can be recycled and re-used for the preparation of said oil-in-water nanoemulsion, whereas the recovered final solid residue (i.e. the deoiled solid matrix) can be re-placed “in situ” or it can be re-used (for example, for road fillings or roadbeds) without the need for further treatments.

Alternatively, said solid phase can be re-placed “in situ” or it can be re-used (for example, for road fillings or roadbeds) without being subjected to thermal desorption.

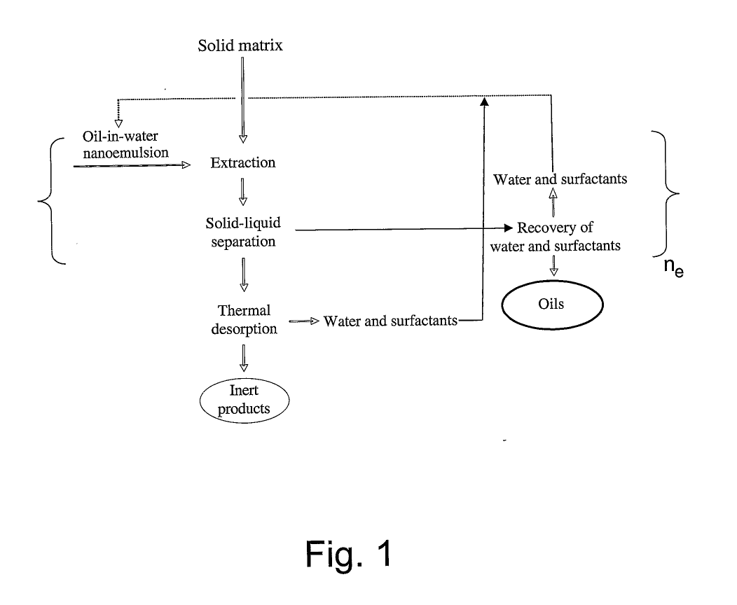

The present invention will now be illustrated through an illustrative embodiment with reference to FIG. 1 reported below.

FIG. 1 schematically represents an embodiment of the process object of the present invention. The solid matrix (e.g. tar sand), is subjected to extraction by mixing with an oil-in-water nanoemulsion obtaining a solid-liquid mixture. Said solid-liquid mixture is subjected to separation, preferably by sedimentation, obtaining a liquid phase comprising said oils, water and surfactants, and a solid phase comprising said solid matrix. Said liquid phase is sent for the recovery of said oils (i.e. the oils present in the solid matrix), preferably by the addition of at least one oil-absorbing polymer obtaining oils and water comprising surfactants deriving from the oil-in-water nanoemulsion. The oils thus obtained can be sent to subsequent upgrading treatments (not represented in FIG. 1) whereas the water comprising the surfactants is recycled and re-used for the preparation of the oil-in-water nanoemulsion. In order to prepare the oil-in-water nanoemulsion, said water comprising surfactants must generally be integrated with one or more surfactants.

As represented in FIG. 1, said solid phase is subjected to low-temperature thermal desorption in order to recover a solid phase comprising said solid matrix (i.e. inert products) and water and surfactants deriving from the oil-in-water nanoemulsion which are recycled and re-used for the preparation of the oil-in-water nanoemulsion. In order to prepare the oil-in-water nanoemulsion, said water and surfactants must generally be integrated with one or more surfactants.

As represented in FIG. 1, the solid matrix can be subjected to extraction with oil-in-water nanoemulsion (nₑ) times, preferably from 1 to 10 times, more preferably from 1 to 3 times.

Some illustrative and non-limiting examples are provided for a better understanding of the present invention and for its embodiment.

### EXAMPLE 1

(1) Preparation of the Oil-in-water Nanoemulsion Precursor

0.121 g of Atlox 4913 (grafted polymethylmethacrylate-polyethylene glycol copolymer of Uniqema), 0.769 g of Span 80 (sorbitan monooleate of Fluka), 3.620 g of Glucopone 600 CS UP (alkylpolyglucoside of Fluka, 50% solution in water) and 6.150 g of xylene, were added to a 50 ml beaker, equipped with a magnetic stirrer, and the whole mixture was maintained under stirring until complete dissolution. When the dissolution was complete, 4.340 g of deionized water were added, maintaining the mixture under mild stirring for 2 hours, obtaining 15 g of a precursor having a HLB equal to 12.80.

Said precursor was left to stabilize for 24 hours, at room temperature (25° C.), before its use.

(2) Preparation of the Oil-in-water Nanoemulsion

0.325 g of Glucopone 215 CS UP (alkylpolyglucoside of Fluka, 606 solution in water) and 2.236 g of deionized water, were added to a 20 ml glass vial and the whole mixture was maintained under stirring until complete dissolution. When the dissolution was complete, 2.439 g of the precursor obtained as described above were added and the whole mixture was maintained under mild stirring for 2 hours obtaining a nanoemulsion having a transparent-translucid appearance, a HLB equal to 13.80 and a xylene content equal to 20% by weight with respect to the total weight of the nanoemulsion.

Said nanoemulsion was used to obtain, by dilution with deionized water, the nanoemulsions with a different xylene content (% by weight) reported in Table 1.

TABLE 1

| | Total | | |
|---|---|---|---|
| Oil-in-water | surfactants | Water | Xylene |
| nanoemulsion | (% by weight)* | (% by weight)* | (% by weight)* |
| (a) | 0.6 | 98.4 | 1 |
| (b) | 1.2 | 96.8 | 2 |
| (c) | 1.8 | 95.2 | 3 |
| (d) | 2.4 | 93.6 | 4 |
| (e) | 3.6 | 90.4 | 6 |
| (f) | 12 | 68.0 | 20 |

*% by weight with respect to the total weight of the nanoemulsion.

The nanoemulsions obtained as described above, have droplets of dispersed phase (xylene) having dimensions ranging from 40 nm to 60 nm, a polydispersity index lower than 0.2 and they are stable for more than six months.

### EXAMPLE 2

5 g samples of tar sand having the characteristics reported in Table 2 were crushed manually in a mortar and sieved using an aluminum sieve having 4 mm meshes. The samples thus prepared were subjected to extraction using the nanoemulsions with different xylene concentrations obtained as described above and reported in Table 1.

TABLE 2
CHARACTERISTICS

| | |
|---|---|
| Oil content (% by weight)⁽¹⁾ | 13 |
| Water content(% by weight)⁽²⁾ | <4 |
| Acid number⁽³⁾ | 7 |
| Kinematic viscosity⁽⁴⁾ (cps) | 10000 |
| API (°)⁽⁵⁾ | 5 |

⁽¹⁾determined by weighing the extract with respect to the total weight of the sample of starting tar sand after extraction in Soxhlet using methylene chloride as extraction solvent;
⁽²⁾determined using a Dean Stark apparatus and toluene as extraction solvent;
⁽³⁾determined according to the Standard ASTM D664-09 (mg of KOH per g of sample);
⁽⁴⁾determined according to the Standard ASTM D2170-07;
⁽⁵⁾determined according to the Standard ASTM D287-92(2006).

For the above purpose, 5 ml of the oil-in-water nanoemulsion, whose characteristics are reported in Table 3, was added to each sample to be tested. For comparative purposes, a sample was prepared to which 5 ml of deionized water was added (sample 1 of Table 3).

TABLE 3

| | Concentration | Quantity of | | |
|---|---|---|---|---|
| | of xylene in | xylene with | | |
| | oil-in-water | respect to | | |
| | nanoemulsion | the oils | pH of | pH of |
| | (% by | (% by | nano- | nano- |
| SAMPLE | weight)⁽¹⁾ | weight)⁽²⁾ | emulsion | emulsion⁽³⁾ |
| 1 | 0 | 0 | 7.53⁽⁴⁾ | 11.67⁽⁵⁾ |
| (comparative) | | | | |
| 2 | 1 | 7.7 | 7.45 | 11.45 |
| 3 | 2 | 15.4 | 8.46 | 11.52 |
| 4 | 3 | 23.1 | 8.53 | 11.56 |
| 5 | 4 | 30.1 | 8.60 | 11.60 |
| 6 | 6 | 46.2 | 8.74 | 11.65 |

⁽¹⁾% by weight with respect to total weight of the nanoemulsion;
⁽²⁾% by weight with respect to total weight of the oils contained in the sample of tar sand;
⁽³⁾pH of the nanoemulsion after addition of the base (sodium carbonate 1M as described hereunder);
⁽⁴⁾pH of the deionized water as such;
⁽⁵⁾pH of the deionized water after addition of the base (sodium carbonate 1M as described hereunder).

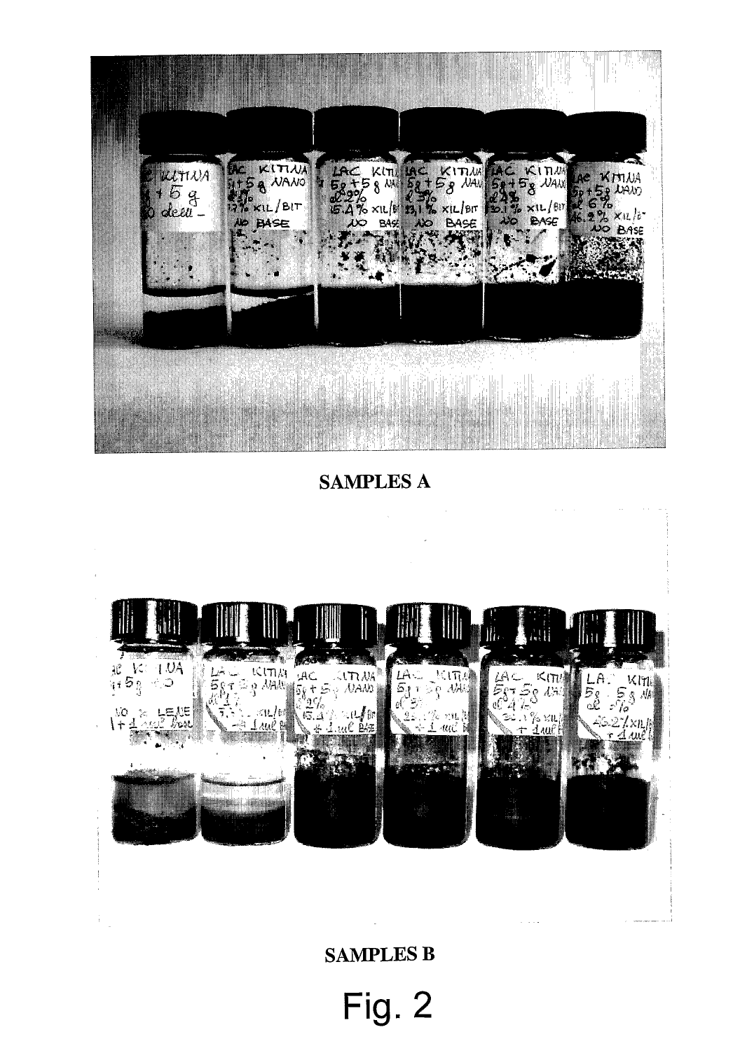

The samples were heated to 60° C. for 5 minutes and stirred by means of a vortex mixer, at the maximum rate, for 1 minute. At the end of the stirring, the samples were left in a balancing water bath, at 60° C., for 30 minutes. The samples were then removed from the water bath, positioned on a bench at room temperature (25° C.) and left to settle. When they had settled, the samples obtained were photographed (Samples A) and are shown in FIG. 2.

Samples were also prepared, operating as described above, using 5 ml of the nanoemulsions reported in Table 3 to which, however, 1 ml of a solution of sodium carbonate 1 M had been added. For comparative purposes, a sample was prepared to which 5 ml of deionized water were added, containing 1 ml of a sodium carbonate solution 1 M. The samples thus obtained were photographed (Samples B) and are shown in FIG. 2.

FIG. 2 shows the photographs of the six samples (Samples A) containing tar sand and oil-in-water nanoemulsion at increasing concentrations of xylene (from left to right).

FIG. 2 shows the photographs of the six samples (Samples B) containing tar sand and oil-in-water nanoemulsion at increasing concentrations of xylene with the addition of 1 ml of a solution of sodium carbonate 1 M (from left to right).

It can be observed how the use of the oil-in-water nanoemulsion allows a good extraction of the oils, already at low concentrations of xylene (i.e. 20).

### EXAMPLE 3

5 g samples of tar sand having the characteristics reported in Table 2 were crushed manually in a mortar and sieved using an aluminum sieve having 4 mm meshes. The samples thus prepared were subjected to extraction using an oil-in-water nanoemulsion having a xylene concentration equal to 2% by weight prepared as described above in Example 1 and having the characteristics reported in Table 1 for the oil-in-water nanoemulsion (b).

For the above purpose, 5 ml of the above oil-in-water nanoemulsion were added to the sample, to which 1 ml of a solution of sodium carbonate 1M had been added, whose characteristics are reported in Table 4.

For comparative purposes, a sample was prepared, to which 4.9 ml of deionized water were added, to which 0.1 ml of xylene and 1 ml of a solution of sodium carbonate 1M had been added (sample 2 of Table 4).

TABLE 4

| | | Quantity of | |
|---|---|---|---|
| | | xylene with | |
| | Concentration | respect to | |
| | of xylene | the oils | pH of |
| SAMPLE | (% by weight)⁽¹⁾ | (% by weight)⁽³⁾ | nanoemulsion |
| 1 | 2⁽¹⁾ | 15.4 | 11.52 |
| 2 | 2⁽²⁾ | 15.4 | 11.52 |
| (comparative) | | | |

⁽¹⁾% by weight with respect to the total weight of the nanoemulsion;
⁽²⁾% by weight with respect to the total weight of the solution of xylene in water;
⁽³⁾% by weight with respect to the total weight of the oils contained in the sample of tar sand.

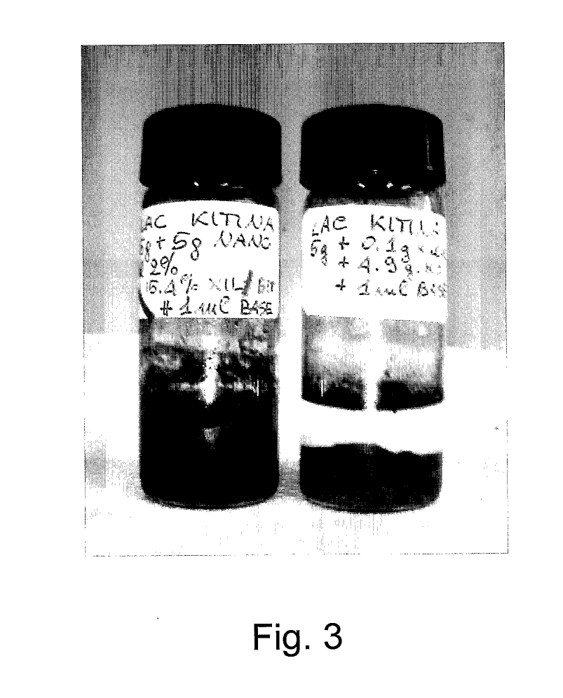

The samples were heated to 60° C. for 5 minutes and stirred by means of a vortex mixer, at the maximum rate, for 1 minute. At the end of the stirring, the samples were left in a balancing water bath, at 60° C., for 30 minutes. The samples were then removed from the water bath, positioned on a bench at room temperature (25° C.) and left to settle. When they had settled, the samples obtained were photographed and are shown in FIG. 3.

FIG. 3 shows the photographs of the two samples containing tar sand and oil-in-water nanoemulsion and tar sand and solvent/water mixture (i.e. xylene/water) (from left to right).

It can be observed how the use of the oil-in-water nanoemulsion allows to obtain a higher extraction yield of the tar with respect to the solvent/water mixture for the same quantity of xylene, i.e. 15.4% by weight with respect to the total weight of the oils contained in the sample of tar sand.

### EXAMPLE 4

50 g of tar sand having the characteristics reported in Table 2, after being crushed manually in a mortar and sieved using an aluminum sieve having 4 mm meshes, were introduced into a 250 ml glass reactor and heated to 60° C., for 30 minutes, under stirring at 200 rpm. 50 g of a nanoemulsion were then added, containing 2.5% by weight of xylene with respect to the total weight of the nanoemulsion and having a pH equal to 8.5, obtained by dilution, with deionized water, of the nanoemulsion having a xylene content equal to 206 by weight with respect to the total weight of the nanoemulsion prepared in Example 1 (2): the whole mixture was stirred for 30 minutes, at 60° C., under stirring at 200 rpm.

At the end of the stirring, a solid phase was obtained, comprising sand which settled on the bottom and a liquid phase comprising oils. To recover the oils, 40 ml of deionized water, preheated to 60° C. and 2.5 g of an oil-absorbing polymer were added to said liquid phase: the whole mixture was left, at 60° C., for minutes, under stirring at 500 rpm, until the complete absorption of the oils. The oil-absorbing polymer comprising the oils was separated by filtration from the liquid phase (which proved to be completely clean of oils). The oils were subsequently recovered from the oil-absorbing polymer by centrifugation.

The sand which had settled on the bottom was subjected to drying and proved to be completely clean: the oils recovery was therefore total.

1. A process for recovering an oil from a solid matrix, the process comprising:
(I) mixing a solid matrix comprising an oil with an oil-in-water nanoemulsion, to obtain a solid-liquid mixture;
(II) separating the solid-liquid mixture, to obtain a liquid phase comprising the oil and a solid phase comprising a final solid matrix;
(III) recovering the oil from the liquid phase.

2. The process of claim 1, wherein the oil-in-water nanoemulsion comprises a dispersed phase comprising oil and a dispersing phase comprising water and a surfactant.

3. The process of claim 1, wherein the liquid phase comprises water and surfactants-deriving the surfactant from the oil-in-water nanoemulsion.

4. The process of claim 1, wherein the solid matrix is selected from the group consisting of a water wet oil sand, a water wet tar sand, an oil wet sand, an oil wet tar sand, an oil rock, and an oil shale.

5. The process of claim 4, wherein the solid matrix is selected from the group consisting of an oil wet sand and an oil wet tar sand.

6. The process of claim 2, wherein the dispersed phase of the oil-in-water nanoemulsion is distributed in the dispersing phase in the form of droplets having a diameter in the range from 10 nm to 500 nm.

7. The process of claim 6, wherein the droplets have a diameter ranging from 15 nm to 200 nm.

8. The process of claim 1, wherein the oil-in-water nanoemulsion is prepared by a process comprising:
mixing water an oil, at least two surfactants having a different HLB, selected from the group consisting of a non-ionic surfactant, an anionic surfactant, and a polymeric surfactant, to obtain a homogeneous water/oil mixture (1) having an interface tension lower than or equal to 1 mN/m,
wherein a content of water in the mixture (1) is in a range from 65% to 99.9% by weight, based on a total weight of the mixture (1), and a content of the surfactants is such that the mixture (1) is homogeneous; and
(B) diluting the mixture (1) in a dispersing phase consisting of water with the addition of at least one surfactant selected from the group consisting of a non-ionic surfactant, an anionic surfactant, and a polymeric surfactant surfactants, to obtain the nanoemulsion,
wherein a content of the dispersing phase and the surfactant is such that the oil-in-water nanoemulsion has an HLB higher than the mixture (1).

9. The process of claim 1, wherein the oil-in-water nanoemulsion has an HLB value higher than or equal to 9.

10. The process of claim 9, wherein the oil-in-water nanoemulsion has an HLB value ranging in a range from 10 to 16.

11. The process of claim 1, wherein the dispersed phase is distributed in the dispersing phase of the oil-in-water nanoemulsion in the form of droplets having a specific area (area/volume) ranging in a range from 6,000 m²/l to 300,000 m²/l.

12. The process of claim 11, wherein the droplets having have a specific area (area/volume) ranging in a range from 15,000 m²/l to 200,000 m²/l.

13. The process of claim 2, wherein a content of the surfactant in the oil-in-water nanoemulsion is in a range from 0.1% to 20% by weight, based on a total weight of the oil-in-water nanoemulsion.

14. The process of claim 13, wherein a content of the surfactant in the oil-in-water nanoemulsion is in a range from 0.25% to 12% by weight, based on a total weight of the oil-in-water nanoemulsion.

15. The process of claim 2, wherein a content of oil in the oil-in-water nanoemulsion is in a range from 0.5% to 10% by weight, based on a total weight of the oil-in-water nanoemulsion.

16. The process of claim 15, wherein a content of oil in the oil-in-water nanoemulsion is in a range from 1% to 8% by weight, based on a total weight of the oil-in-water nanoemulsion.

17. The process of claim 2, wherein the surfactant is at least one selected from the group consisting of a non-ionic surfactant and a polymeric surfactant.

18. The process of claim 1, wherein the oil is at least one selected from the group consisting of an aromatic hydrocarbon a linear hydrocarbon, a branched hydrocarbon, a cyclic hydrocarbon, and a complex mixtures mixture of hydrocarbons.

19. The process of claim 1, wherein the water is at least one selected from the group consisting of demineralized water, saline water, and added water.

20. The process of claim 1, wherein a weight ratio between the solid matrix and the oil-in-water nanoemulsion in the solid-liquid mixture is in a range from 1:0.1 to 1:2.

21. The process of claim 20, wherein the weight ratio between the solid matrix and the oil-in-water nanoemulsion is in a range from 1:0.5 to 1:1.

22. The process of claim 1, wherein in the solid/liquid mixture, a content of oil in the oil-in-water nanoemulsion is in a range from 0.1% to 30% by weight, based on a total weight of oil present in the solid matrix.

23. The process matrix of claim 22, wherein the content of the oil in the oil-in-water nanoemulsion is in a range from 1% to 25% by weight, based on a total weight of the oil present in the solid matrix.

24. The process of claim 1, further comprising:
adding a base to the oil-in-water nanoemulsion, in a content in a range from 0.1% to 10% by weight, based on a total weight of the oil-in-water nanoemulsion.

25. The process of claim 24, wherein the base is added to the oil-in-water nanoemulsion, in a content in a range from 0.2% to 5% by weight, based on a total weight of the oil-in-water nanoemulsion.

26. The process of claim 24, wherein the base is at least one selected from the group consisting of sodium hydroxide, potassium hydroxide, sodium carbonate, and potassium carbonate.

27. The process of claim 1, wherein the mixing (I) is carried out for a time in a range from 5 minutes to 5 hours.

28. The process of claim 27, wherein the mixing (I) is carried out for a time in a range from 6 minutes to 2 hours.

29. The process of claim 1, wherein the mixing (I) is carried out at a temperature in a range from 5° C. to 90° C.

30. The process of claim 29, wherein the mixing (I) is carried out at a temperature in a range from 20° C. to 80° C.

31. The process of claim 1, wherein the mixing (I) is carried out at a pH in a range from 7 to 13.

32. The process of claim 31, wherein the mixing (I) is carried out at a pH in a range from 8 to 12.

33. The process of claim 1, wherein the separating (II) is carried out by sedimentation or centrifugation.

34. The process of claim 1, wherein a content of oil in the liquid phase is higher than or equal to 60% by weight, based on a total weight of oil present in the solid matrix.

35. The process of claim 34, wherein a content of oil in the liquid phase is in a range from 70% to 99.9% by weight, based on a total weight of oil present in the solid matrix.

36. The process of claim 1, wherein a content of oil in the solid phase is lower than or equal to 40% by weight based on a total weight of oil present in the solid matrix.

37. The process of claim 36, wherein a content of oil in the solid phase is in a range from 0.1% to 30% by weight, based on a total weight of oil present in the solid matrix.

38. The process of claim 1, wherein the recovering (III) is carried out by centrifugation, cyclonation, filtration, or flotation.

39. The process of claim 1, further comprising:
heating the solid phase to a temperature in a range from 50° C. to 150° C.
